(19) United States
(12) Patent Application Publication
(10) Pub. No.: US 2005/0172542 A1
(43) Pub. Date: Aug. 11, 2005

(54) Apparatus for trapping flying insects

(76) Inventor: Donnie Rose SR., Kettleman City, CA (US)

Correspondence Address: RICHARD A. RYAN, ATTORNEY AT LAW, 8497 N. MILLBROOK AVENUE, SUITE 104, FRESNO, CA, 93720, US

(21) Appl. No.: 10/774,145

(22) Filed: Feb. 6, 2004

(51) Int. Cl. A01M 1/04; A01M 1/14

(52) U.S. Cl. 43/113; 43/114

(57) ABSTRACT

An apparatus for trapping flying insects that is particularly configured for use in agricultural areas such as orchards and fields to allow inspection and elimination of such insects. The apparatus has an elongated vertical member or pole configured to mount into the ground or cooperate with a separate member mounted into the ground. An insect attracting light source and an insect immobilizing element are mounted to the pole. The light is provided by one or more light bulbs. The insect immobilizing element comprises a mesh screen panel covered with a sticky substance to provide an adhesive surface. A rechargeable battery is connected to the light source. A solar recharge system having a solar panel mounted to the top of the pole recharges the battery. For ease of handling and installation, the pole can be provided in multiple interconnecting sections. A photosensitive element controls the on/off function of the light source.

### CROSS-REFERENCE TO RELATED APPLICATIONS

Not Applicable.

### BACKGROUND OF THE INVENTION

A. Field of the Invention

The field of the present invention relates generally to apparatuses for trapping and exterminating flying insects. More specifically, the present invention relates to such apparatuses that have a source of insect attracting light and an adhesive surface for immobilizing flying insects attracted to the apparatus by the light. Even more specifically, the present invention relates to such apparatuses that are particularly configured for use in orchards and agricultural fields and that are adaptable for use with a solar recharging system.

B. Background

Although certain flying insects are known to be beneficial to growing crops, other flying insects are known to be very harmful to crop production. The efforts and costs associated with these problem insects can be significant issues for certain crops. As an example of the problems faced by the agricultural industry with regard to flying insects, pistachio and almond growers have well known and documented problems with the navel orange worm (Amyelois transitella), which in its adult stage is a moth-like insect. The navel orange worm attacks soft-shelled cultivars, or nuts with poor seals. With regard to pistachios, the navel orange worm is considered the major insect problem in California and other pistachio growing areas. In the almond industry, thirty percent damage to the nut crop in not uncommon in late harvested orchards. In the spring, the adult female lays its eggs in skin cracks, leaving the larvae to feed on the kernels inside the nuts. In addition to insect excrement and physical damage, such as destruction of kernels and creation of channels in remaining kernels, which can cause the nuts to be unsalable, the presence of navel orange work infestation is associated with very high levels of aflatoxin. Aflatoxin, a widely known and studied member of the mycotoxin family, is among the most potent mutagenic substances known and, as a carcinogen, is believed to induce liver cancer. Growers must spend significant resources and costs to fight navel orange worm infestation, inspect their crops for damage from these insects and remove any damaged nuts. Insect traps, such as egg traps, are utilized in the orchards and other agricultural areas to monitor the navel orange worm so as to provide the proper timing for applying insecticide to the crops.

The use of traps for attracting and immobilizing or eliminating flying insects is generally well known. Although various types of trapping apparatuses are available, these apparatuses typically utilize a mechanism for attracting the flying insects to the trap and a cooperating mechanism for catching, immobilizing or exterminating the flying insects. Mechanisms for attracting flying insects include light sources, chemicals and gasses. The known immobilizing or exterminating mechanisms for the various flying insect trapping apparatuses can be grouped in several broad categories, namely electrification devices, devices having an adhesive or sticky surface, fan devices and enclosure devices. The electrification devices typically utilize a plurality of wires configured in a grid or mesh connected to an electrical power source such that any flying insects that come into contact with or fly within the area of the wire grid or mesh are electrocuted. The sticky surface devices typically utilize a rigid or semi-rigid board coated or covered with an adhesive substance, which can be applied directly to the board or incorporated in a paper material, for immobilizing insects that come into contact with the board. Insects stuck on the board will, if left thereon, die. Pesticides and other materials are often utilized to speed up the exterminating process. The devices utilizing a fan as the exterminating device typically have rotating fan blades or wire spokes that serve as the eradicating device to kill the insects by contact with the blades or spokes. Enclosure devices typically have a bag or other container that is configured to trap the insects and contain them therein until they die or are otherwise exterminated. Some of the enclosure device utilize a fan as a suction device to draw flying insects into the bag or container.

Examples of the various flying insect trapping apparatuses are described in the prior art. For instance, U.S. Pat. No. 5,915,948 to Kunze et al., describes an insect attractant device that utilizes a light source to attract the insects and an adhesive board to immobilize them. This patent also discusses the use of pheromones to attract the insects to the device and the use of insecticide compositions to kill the insects on contact therewith. U.S. Pat. No. 5,259,153 to Olive et al., describes an insect trap that utilizes a solar energy rechargeable battery-powered light source and pan having a sheet of sticky flypaper. U.S. Pat. No. 6,594,944 to Chura describes an insect collecting apparatus that utilizes a propane burner to produce carbon dioxide gas to attract insects and an electrified grid for exterminating the insects. U.S. Pat. No. 6,421,952 to Vascocu describes an insect attracting and exterminating apparatus that utilizes a light source to attract insects and a pair of spaced apart electrified wire meshes to create an electrified killing zone for eliminating the insects. U.S. Pat. No. 6,574,914 to Smith describes a flying insect trap that has a light source inside a translucent cover with an axial flow fan to draw the flying insects into the cover and force them onto a tray having sticky fly paper thereon to immobilize the insects. U.S. Pat. No. 3,123,933 to Roche describes an insect eradicator that utilizes a light source to attract the insects and a suction fan to draw the insects into a contra-rotating, multi-wire spoke eradicator wheel that kills the insects on contact. U.S. Pat. No. 2,931,127 to Mayo, U.S. Pat. No. 4,141,173 to Weimert et al. and U.S. Pat. No. 5,329,725 to Bible all describe apparatuses that utilize a light source to attract flying insects and a suction fan to draw the insects into a porous/mesh bag or sack receptacle. U.S. Pat. No. 6,502,347 to Carver, Sr. describes a lighted insect trap that has a light enclosed in a housing having a detachable base portion adapted to hold a liquid for drowning or poisoning insects.

While the various apparatuses described above, as well as others known in the art, are generally able to trap and/or exterminate flying insects, they have limitations that render them somewhat unsuitable for use in certain applications, such as in orchards, fields and other agricultural areas. The known apparatuses are typically not suitable for this type of use due to various factors, including the complexity of their configuration, requirements for wired electrical or other power sources, need to frequently replace the materials used to attract, immobilize or exterminate the insects and the prohibitive costs associated with placing such apparatuses in various places throughout the orchard, field or other agricultural area. In addition, most such apparatuses are configured to eliminate all flying pests that are attracted to the apparatus. Besides being generally unnecessary in agricultural areas, it also creates problems with the apparatuses due to relatively rapid filling or utilization of the mechanism for immobilizing or exterminating the insects. For instance, light sources commonly attract many thousands of small gnats, which can clog the mechanism and prevent or reduce the effectiveness of the apparatus without achieving any significant pest reduction benefit. What is needed, therefore, is an apparatus for trapping flying insects that is particularly suitable for use in agricultural areas, such as orchards and fields, and effective for attracting and trapping the desired flying insects so the user can determine the need for applying insecticides or other insect preventative measures. The preferred apparatus should be relatively inexpensive to manufacture and install and simple to operate so that they can be used in large or small scale growing operations. Because the apparatus will be used in agricultural areas where electrical lines may not be available, the apparatus should be adaptable for use with a self-contained power supply system. The preferred apparatus should also allow the user to change the mechanism for immobilizing or exterminating the flying insects as needed or desired to prevent such mechanism becoming unuseable due to clogging.

### SUMMARY OF THE INVENTION

The apparatus for trapping flying insects of the present invention solves the problems and provides the benefits identified above. That is to say, the present invention discloses an apparatus for trapping and immobilizing flying insects that is particularly configured to be used in agricultural areas such as orchards and fields. The apparatus attracts and traps flying insects and, in the preferred configuration, avoids trapping gnats or other small insects that would otherwise clog the immobilizing portion of the apparatus. The apparatus of the present invention allows the user to easily inspect the immobilizing portion so that he or she can determine the need to apply insecticides or take other insect preventative measures when the beginning of an insect infestation becomes apparent. The preferred configuration for the apparatus of the present invention is relatively inexpensive to manufacture and easy to install in various places throughout the agricultural area. Once set-up, the apparatus is easy to use, requiring relatively little human intervention. The preferred configuration of the apparatus includes a self-contained, rechargeable power system that does not require access to electrical power lines. The insect immobilizing portion of the apparatus of the present invention can be relatively easily replaced when needed or desired.

In one aspect of the present invention, the apparatus for trapping flying insects has an elongated vertical support member or pole, having a first end and a second end, on which is mounted an insect attracting light source and an insect immobilizing element. For ease of handling and installation, the elongated support member comprises separate pole sections. In the preferred embodiment, at least the first end of the vertical support member is tubular. A ground support member is mounted to a support surface, such as the ground, and is configured to be at least partially inserted into the support surface. The upstanding portion of the ground support member is configured to cooperatively engage the first end of the vertical support member so as to support the vertical support member in a generally vertical position above the support surface. In the preferred embodiments, the first end of the vertical support member is configured to be slid over, placed into or attached to the ground support member. The insect attracting light has at least one light bulb, such as a fluorescent ultraviolet light bulb, suitable for attracting the desired flying insects. A photosensitive element can be used to automatically control the on/off operation of the light bulb. The insect immobilizing has a mesh screen with a plurality of openings therein with one or more adhesive surfaces placed on the mesh screen that comprise a sticky substance placed on the mesh screen. In the preferred embodiment, the mesh screen openings are large enough to allow small flying insects, such as gnats and the like, to pass so as to not unduly cover the immobilizing element. Also in the preferred embodiment, the electrical power is supplied by a rechargeable battery that is electrically connected to the insect attracting light and to a recharging mechanism, such as a solar panel, for recharging the battery.

Accordingly, the primary objective of the present invention is to provide an improved apparatus for trapping flying insects that provides the advantages discussed above and that overcomes the disadvantages and limitations associated with presently available flying insect traps.

It is also an important objective of the present invention to provide an apparatus for trapping flying insects that is particularly configured for use in agricultural areas such as orchards and fields, adaptable to trapping a variety of different types of flying insects and useful for determining the types and number of insects trapped.

It is also an important objective of the present invention to provide an apparatus for trapping flying insects that is relatively inexpensive to manufacture and easy to use.

It is also an important objective of the present invention to provide an apparatus for trapping flying insects that is configured to avoid becoming clogged or otherwise having reduced effectiveness by gnats and other very small flying insects.

It is also an important objective of the present invention to provide an apparatus for trapping flying insects that comprises a ground support mechanism for mounting the apparatus in the ground, an elongated pole for supporting the light and immobilizing mechanisms, and a self-contained power supply system.

The above and other objectives of the present invention will be explained in greater detail by reference to the attached figures and the description of the preferred embodiment which follows. As set forth herein, the present invention resides in the novel features of form, construction, mode of operation and combination of processes presently described and understood by the claims.

### BRIEF DESCRIPTION OF THE DRAWINGS

In the drawings which illustrate the best modes presently contemplated for carrying out the present invention:

FIG. 1 is a side view of the apparatus for trapping flying insects of the present invention;

FIG. 2 is an exploded side view of the apparatus for trapping flying insects of the present invention shown in FIG. 1;

FIG. 3 is an isolated side view of the center section having the light and immobilizing mechanisms of the apparatus for trapping flying insects of the present invention shown in FIG. 1;

FIG. 4 is an isolated side view of an alternative configuration for the interaction between the lower pole section of the vertical support member and the ground support member;

FIG. 5 is an isolated side view of another alternative configuration for the interaction between the lower pole section of the vertical support member and the ground support member; and

FIG. 6 is an isolated side view of an alternative configuration for the first end of the vertical support member of the apparatus of the present invention.

### DETAILED DESCRIPTION OF THE PREFERRED EMBODIMENTS

With reference to the figures where like elements have been given like numerical designations to facilitate the reader's understanding of the present invention, and particularly with reference to the embodiment of the apparatus for trapping flying insects of the present invention illustrated in the figures, the preferred embodiments of the present invention are set forth below. The enclosed figures and drawings are merely illustrative of the preferred embodiments and represent several different ways of configuring the present invention. Although specific components, materials, configurations and uses of the present invention are illustrated and set forth in this disclosure, it should be understood that a number of variations to the components and to the configuration of those components described herein and in the accompanying figures can be made without changing the scope and function of the invention set forth herein.

A preferred embodiment of the apparatus for trapping flying insects of the present invention, identified generally as 10 in the figures, primarily comprises a vertical support member 12 having a first end 14 and second end 16, a source of insect attracting light 18, an insect immobilizing element 20 and a source of electrical power 22, as collectively shown in FIGS. 1 and 2. In the preferred embodiment, vertical support member 12 is a pole or other elongated member configured to be held in a generally vertical position relative to a support surface, such as ground 24, by ground support unit 26. First end 14 of vertical support member 12 is configured to cooperate with ground support unit 26 so as to securely hold vertical support member 12, and the components mounted thereon, above ground 24. In one configuration, shown in FIGS. 1 and 2, ground support unit 26 is a rod 28 that is adapted to be partially driven into ground 24 and shaped and configured to hold vertical support member 12 in generally upright position. The specific size, type and configuration of ground support unit 26 will generally be dependent on such factors as the weight of the materials selected for vertical support member 12 and the components mounted thereon, the condition of ground 24 where apparatus 10 will be used (i.e., firm or relatively soft), the wind, snow or other ambient loading factors and the configuration of the first end of vertical support member 12. In one example configuration, rod 28 is a six foot long metal rod having a one inch diameter cross-section. If desired, the end of rod 28 that is to be driven into ground 24 can have a pointed or angled shape to make it easier for the user to drive rod 28 partially into ground 24.

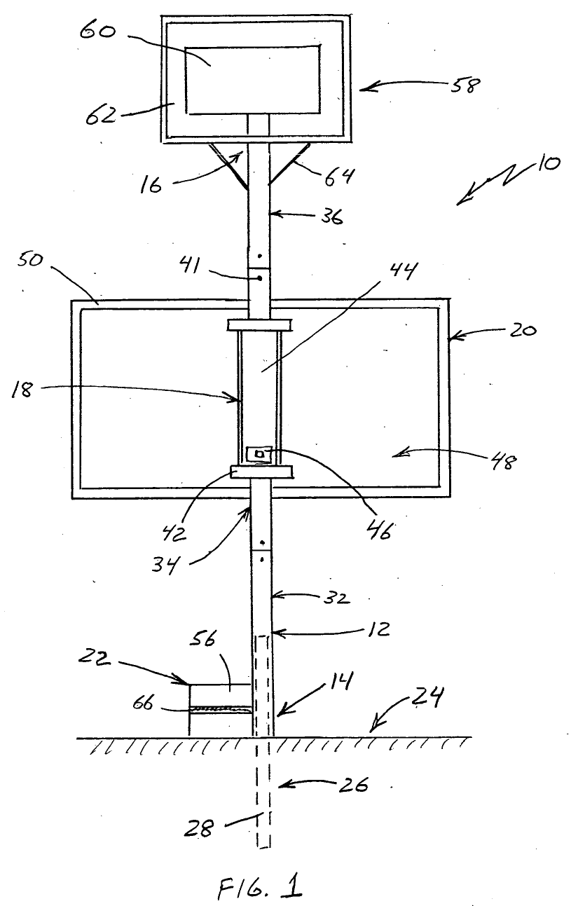

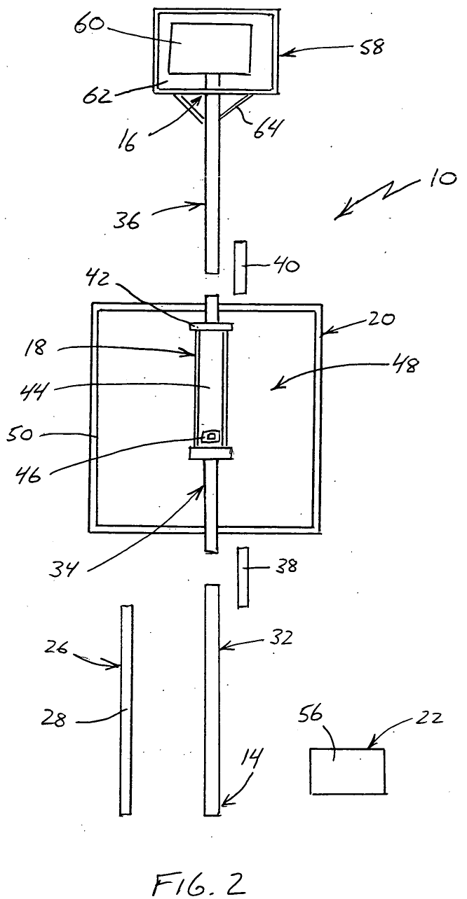

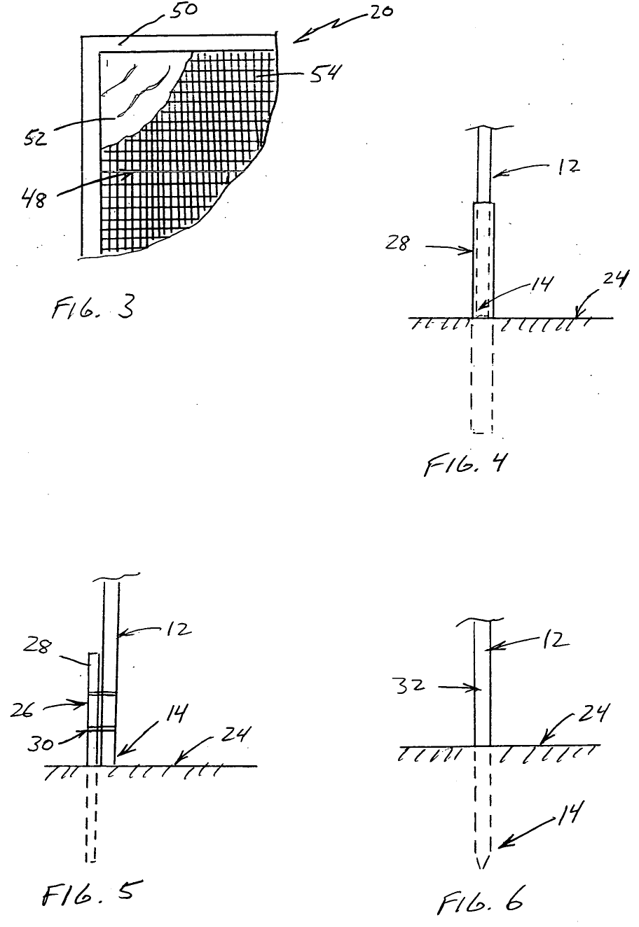

As stated above, first end 14 of vertical support member 12 is configured to cooperate with ground support unit 26 to hold vertical support member 12 in a generally upright, vertical position, as shown in FIG. 1. In a preferred embodiment, at least the first end 14 of vertical support member 12 is tubular so that first end 14 can be placed over rod 28 to hold vertical support member 12 generally upright. In this embodiment, first end 14 should have an inside diameter that is sized and configured to be only slightly larger than rod 28 to prevent undo movement of vertical support member 12. For the example configuration of rod 28 given above, for instance, first end 14 can be tubular with a one and one-fourth diameter circular cross-section. As known to those skilled in the art, various other configurations are possible for ground support member 26 and first end 14 of vertical support member 12. For instance, as shown in FIG. 4, at least the upper end of ground support member 26 can be tubular and first end 14 of vertical support member 12 can be configured to be inserted inside ground support member 26 or, as shown in FIG. 5, first end 14 of vertical support member 12 can be configured to externally attach to ground support member 26, such as rod 28, through use of one or more attachment mechanisms 30, such as the straps shown or bolts, screws, brackets and the like.

Vertical support member 12 can be made out of various materials, such as fiberglass, plastic, metal, composites, wood and the like, which are suitable for safely mounting the various components thereon. The material for vertical support member 12 should be sufficiently strong and rigid to support itself and all or some of the remaining components, as set forth below, off ground 24. Because the apparatus 10 of the present invention is particularly configured and useful for outdoor agricultural areas such as orchards and fields, the material selected for vertical support member 12 should be generally corrosion resistant or suitable for coating with material that is generally corrosion resistant. The preferred materials for vertical support member 12 are fiberglass, plastic and certain composites that are much less likely to attract lighting thereto. If desired, first end 14 of vertical support member 12 can be shaped and configured to allow direct insertion of vertical support member 12 into ground 24, thereby eliminating the need for a separate ground support member 26, as shown in FIG. 6. One way to facilitate the use of a shaped first end 14 that can be directly driven into ground 24 is for vertical support member 12 to be comprised of separate pole sections, such as lower pole section 32, center pole section 34 and upper pole section 36 shown in FIGS. 1 and 2. In one configuration, as shown, lower pole section 32 can join with center pole section 34 by use of first connecting element 38 and center pole section 34 and join with upper pole section 36 by use of second connecting element 40. In the figures, at least the ends of pole sections 32, 34 and 36 are tubular and first 38 and second 40 connecting elements are cylindrical dowels that fit within the open tubular ends of the separate pole sections 32, 34 and 36. If necessary or desired, one or more securing mechanisms, such as self-tapping screws 41, can be utilized to secure first 38 and second 40 connecting elements inside pole sections 32, 34 and 36. As known to those skilled in the art, various other mechanisms for connecting separate elongated members together can be utilized for apparatus 10, including a tent pole type of telescopic configuration or the use of brackets and the like. In a configuration having at least a separate lower pole section 32 with a shaped (i.e., pointed, angled and the like) first end 14, the user can apply force to the top of lower pole section 32 to force first end 14 into ground 24 and then connect the remaining section or sections, such as center pole section 34 and upper pole section 36, of vertical support member 12 above lower pole section 32 to form vertical support member 12 of sufficient height for the purposes set forth herein.

In a preferred embodiment, shown in FIGS. 1 and 2, attached to vertical support member 12 is a source of insect attracting light 18, which is comprised of a light housing 42 having one or more light bulbs 44, such as an ultraviolet light bulb or an ultraviolet emitting fluorescent bulb suitable for attracting the desired flying insects to apparatus 10. In general, fluorescent bulbs or other relatively low power usage and long life bulbs are preferred to reduce the power requirements of apparatus 10 and the need to replace light bulb 44. Light bulb 44 should be of the type that is suitable for being powered by the source of electrical power 22 associated with apparatus 10. Although not required for operation of apparatus 10, light housing 42 helps protect light bulb 44 from damage due to contact therewith and provides a more suitable configuration for connecting the necessary wires and/or replacing light bulb 44 as needed. In a preferred embodiment, light housing 42 is configured to securely attach to vertical support member 12 at center pole section 34, as shown in FIGS. 1 and 2, located a desired distance above ground 24 for attracting the flying insects of interest. Bolts, screws, brackets, straps or other well known and widely available connecting mechanisms can be utilized, either as part of light housing 42 or as separate components. The source of insect attracting light 18 of the preferred embodiment also includes photosensitive element 46, such as a photo-cell, that is configured to automatically control the on/off status of light bulb 44, such as by automatically turning light bulb 44 on at dusk or night and off at dawn or morning. If desired, photosensitive element 46 can include a delay mechanism or timer, not shown, that delays the activation or deactivation of light bulb 44 to ensure that intermittent periods of dark or light do not unintentionally turn light bulb 44 on or off or to delay turning light bulb on or off for a set period of time, such as one to two hours.

Apparatus 10 of the present invention also includes an insect immobilizing element 20 that is configured to trap or immobilize flying insects that are attracted to apparatus 10 by the source of insect attracting light 18. In a preferred embodiment, insect immobilizing element 20 is a rigid or semi-rigid panel or other panel-type of configuration having a panel member 48 bounded by frame 50 with one or more adhesive surfaces 52 on panel member 48, as best shown in FIG. 3. In one configuration, immobilizing element 20 is attached, preferably removably, to vertical support member 12 so that it flying insects will become stuck to adhesive surface when they approach apparatus 10 due to light from light bulb 44. In an alternative configuration, immobilizing element 20 attaches to vertical support member 12 via light housing 42. In another alternative embodiment, light housing 42 attaches to immobilizing element 20, which attaches to vertical support member 12. Although a solid panel member 48 can be utilized, the preferred panel member 48 is a mesh screen that has a plurality of openings 54 which are sufficiently sized so that small, not-of-interest flying insects, such as gnats and the like, can pass through panel member 48 without becoming stuck to adhesive surface 52. Although many small flying insects are not of concern or interest to the user of apparatus 10, without sufficiently sized openings 54 these small flying insects would nevertheless tend to become stuck to adhesive surface 52 and clog panel member 48 thereby rendering apparatus 10 less effective for trapping the flying insects that are of particular interest (such as the larger moth-like navel orange worm). An example of a mesh screen panel member 48 that has been found suitable for use with apparatus 10 of the present invention is commonly referred to as hardware cloth, such as that having a plurality of generally square one fourth inch openings 54. Other types of mesh screens will also be suitable for panel member 48 of immobilizing element 20. In a preferred configuration, immobilizing element 20 has a replaceable, disposable panel member 48, such that panel member 48 can be attached and removed from frame 50 as needed or desired to improve the effectiveness of immobilizing element 20. For instance, some types of mesh screen products are available in a roll form that can be unrolled as needed. In another configuration, panel member 48 and frame 50 are an integral or substantially integral unit that are replaced and installed together. Panel member 48 can be made out of a variety of materials, including plastic, metal, fiberglass, composites and the like. As set forth below, it is preferred that panel member 48 substantially allow light from light bulb 44 to pass through so that light will be visible from both sides of immobilizing element 20. A translucent panel member 48 can help diffuse light from light bulb 44 over the entire surface of both sides of panel member 48.

To immobilize flying insects, adhesive surface 52 should comprise a sticky or tacky substance on panel member 48 that is placed on both sides of immobilizing element 20. The material chosen for adhesive surface 52 should be suitable for the flying insects for which apparatus 10 is configured. Examples of sticky substances that has been found to be suitable for some flying insects, such as the navel orange worm, are the Tangle-Trap® and Tanglefoot® adhesives available from The Tanglefoot Company out of Grand Rapids, Mich. Other sticky substances that would also work with apparatus 10 include molasses and table syrup. A variety of other commercially available or individually made sticky substances would also provide a sufficient adhesive surface 52 for apparatus 10 of the present invention. In one configuration of apparatus 10 of the present invention, such as when immobilizing element 20 is substantially affixed to vertical support member 12, the user can “recharge” immobilizing element 20 by adding more sticky substance material to panel member 48, by brushing, rolling or other means, as desired to maintain the effectiveness of apparatus 10. The preferred sticky substance is one that does not require this recharging process to be performed very frequently. If desired, the sticky substance making up adhesive surface 52 can include one or more insecticide agents to more quickly kill the insects trapped thereon and/or an attracting agent (in addition to insect attracting light 18) such as a pheromone product that is specially configured to attract the flying insects of interest. An example of such a product is the pheromone product described in U.S. Pat. No. 4,400,550 to Bishop et al., that sets forth a process for the synthesis of a navel orange worm pheromone.

To power light source 18, apparatus 10 preferably has a self-contained source of electrical power 22, such as battery 56 shown in FIGS. 1 and 2, that is electrically connected to light source 18. In the preferred embodiment, battery 56 is rechargeable and the source of electrical power includes a recharge mechanism 58 for recharging battery 56. Because the primary use for apparatus 10 of the present invention is in agricultural areas such as orchards and fields, the preferred recharge mechanism 58 is a solar power system comprising solar panel 60, having one or more photovoltaic or solar cells, mounted on support plate 62 secured to second end 16 of vertical support member 12. In an alternative configuration, the solar panel 60 is selected so that it can be mounted directly, without support plate 62, to second end 16 of vertical support member 12. In another alternative configuration, solar recharge mechanism 58 can comprise an array made up of a plurality of photovoltaic cells, with or without support plate 62. If needed or preferred, one or more mounting brackets 64 can be utilized to provide additional support for support plate 62. Recharge mechanism 58 is electrically connected to battery 56 to recharge battery 56 during the daylight hours. In a preferred embodiment, support plate 62 is mounted on second end 16 of vertical support member 12 such that it provides a generally planar surface for a substantially unobstructed sunlight exposure for the photovoltaic cells on solar panel 60 mounted thereon. As known to those generally skilled in the use of solar panel 60, it is preferred that the solar panel 60 be positioned in a manner that will provide the most sunlight to the photovoltaic cells for recharging battery 56. Preferably, the height of vertical support member 12 and, therefore, the position of second end 16 should be sufficient to substantially avoid trees, crops or structures from shading or otherwise blocking the sunlight necessary for solar recharge system 58. As an alternative to a solar recharging system 58, recharging system 58 can be wind driven or other types of systems for recharging battery 56.

As shown in FIGS. 1 and 2, battery 56 can be positioned at first end 14 of vertical support member 12 for ease of access so that it may be replaced as necessary. Although not specifically shown, battery 56 is electrically connected to light source 18 and recharge mechanism 58 with one or more sets of wires suitable for the source of electrical power 22 utilized. As known to those skilled in the art, battery 56 may be located elsewhere on vertical support member 12, incorporated into light source 18, incorporated into recharge mechanism 58 or separately mounted on support plate 62. As shown in FIG. 2, one or more straps or other securing mechanisms can be utilized to secure battery 56 to first end 14 of vertical support member 12 or elsewhere on apparatus 10. Various types and power supply capabilities for battery 56 can be utilized for apparatus 10 depending on the requirements of light source 18.

In use, the user of apparatus 10 places apparatus 10 in a location where it is desired to trap flying insects for the purposes of inspecting for possible infestation and/or reducing the quantity of such flying insects. In a preferred embodiment, shown in FIGS. 1 and 2, the user drives one end of rod 28 into ground 24, leaving a sufficient amount of rod 28 above ground 24 to provide an upright support for vertical support member 12. In one configuration, rod 28 is a one inch diameter by six foot length metal rod and vertical support member 12 comprises three tubular sections, lower pole section 32, center pole section 34 and upper pole section 36. First end 14 of vertical support member 12, which can be a one and one fourth inch diameter fiberglass pole, is placed over the above-ground, upstanding portion of rod 28. One half of first connecting element 38 is inserted into the upper end of lower pole section 32 and the lower end of center pole section 34 is placed over first connecting element 38 to join center pole section 34 to lower pole section 32. This process is repeated for center pole section 34 and upper pole section 36. If desired or necessary, securing mechanism 41 can be used to secure the pole sections 32, 34 and 36 together, as appropriate. Light source 18 can be mounted to one side of vertical support member 12 and immobilizing element 20 can be mounted to the opposite side. If not already coated, the appropriate sticky substance for adhesive surface 52 can be applied to panel member 48 by brushing or otherwise applying it thereto. As may be necessary, the appropriate electrical connections can be made to electrically connect light source 18 and recharge mechanism 58 to battery 56. With use of photosensitive element 46, light bulb 44 will automatically turn on at dusk and off at dawn. When on, flying insects will be attracted to light bulb 44 and become stuck on the adhesive surface 52 where they will die and they can be inspected for possible infestation. Depending on the size of openings 54 in panel member 48, smaller sized flying insects, such as gnats and the like, will not become stuck on the adhesive surface 52, thereby preventing undo clogging thereof. As needed, additional sticky substance can be applied to panel member 48 to “recharge” the ability of apparatus 10 immobilize flying insects coming into contact therewith.

While there are shown and described herein certain specific alternative forms of the invention, it will be readily apparent to those skilled in the art that the invention is not so limited, but is susceptible to various modifications and rearrangements in design and materials without departing from the spirit and scope of the invention. In particular, it should be noted that the present invention is subject to modification with regard to the dimensional relationships set forth herein and modifications in assembly, materials, size, shape and use.

1. An apparatus for trapping flying insects, comprising:
an elongated vertical support member having a first end and a second end, said vertical support member configured to be supported in a generally vertical position above a support surface;
an insect attracting light mounted substantially adjacent to said vertical support member;
an insect immobilizing element having a generally rigid or semi-rigid panel member with one or more adhesive surfaces, said insect immobilizing element mounted on said vertical support member in a generally vertical upright position substantially adjacent to said insect attracting light and/or said vertical support member; and
a source of electrical power, said source of electrical power electrically connected to said insect attracting light.

2. The apparatus according to claim 1, wherein said vertical support member is tubular.

3. The apparatus according to claim 1, wherein said vertical support member comprises at least a lower pole section and an upper pole section and said apparatus further comprising a ground support member configured to cooperatively engage said lower pole section.

4. The apparatus according to claim 1, further comprising a ground support member configured to cooperatively engage said first end of said vertical support member.

5. The apparatus according to claim 4, wherein said ground support member is configured to be at least partially inserted into said support surface and said first end of said vertical support member is configured to be slid over, placed into or attached to said ground support member.

6. The apparatus according to claim 1, wherein said first end of said vertical support member is shaped and configured to attach said vertical support member to said support surface.

7. The apparatus according to claim 1, wherein said insect immobilizing element has a frame substantially bounding said panel member.

8. The apparatus according to claim 1, wherein said panel member is a mesh screen having a plurality of openings therein said openings sized and configured to substantially allow small flying insects to pass therethrough without contact with said one or more adhesive surfaces.

9. The apparatus according to claim 1 further comprising a photosensitive element configured to control said insect attracting light.

10. The apparatus according to claim 1, wherein said panel member is replaceable.

11. The apparatus according to claim 1, wherein said adhesive surface comprises a sticky substance.

12. The apparatus according to claim 1, wherein said insect immobilizing element is generally parallel to said vertical support member.

13. The apparatus according to claim 1, wherein said insect immobilizing element is configured to allow light from said insect attracting light to pass therethrough.

14. The apparatus according to claim 13, wherein said source of electrical power is a battery and said apparatus further comprises a solar panel mounted at said second end of said vertical support member, said solar panel electrically connected to said battery and configured to recharge said battery.

15. An apparatus for trapping flying insects, comprising:
an elongated vertical support member having a first end and a second end, said elongated support member comprising one or more pole sections;
a ground support member mounted to a support surface, said ground support member configured to cooperatively engage said first end of said vertical support member and support said vertical support member in a generally vertical position above said support surface;
an insect attracting light mounted substantially adjacent to said vertical support member, said insect attracting light having at least one source of light;
an insect immobilizing element having a generally rigid or semi-rigid panel member with one or more adhesive surfaces, said insect immobilizing element mounted on said vertical support member in a generally vertical upright position substantially adjacent to said insect attracting light and/or said vertical support member; and
a source of electrical power, said source of electrical power electrically connected to said insect attracting light.

16. The apparatus according to claim 15, wherein said ground support member is configured to be at least partially inserted into said support surface and said first end of said vertical support member is configured to be slid over, placed into or attached to said ground support member.

17. The apparatus according to claim 15, wherein said panel member is a mesh screen having a plurality of openings therein, said openings sized and configured to substantially allow small flying insects to pass therethrough without contact with said one or more adhesive surfaces.

18. The apparatus according to claim 15, wherein said source of electrical power is a battery and said apparatus further comprises a solar panel mounted at said second end of said vertical support member, said solar panel electrically connected to said battery and configured to recharge said battery.

19. The apparatus according to claim 18, wherein said insect immobilizing element is configured to allow light from said insect attracting light to pass therethrough.

20. An apparatus for trapping flying insects, comprising:
an elongated vertical support member having a first end and a second end, said elongated support member comprising one or more pole sections;
a ground support member mounted to a support surface, said ground support member configured to be at least partially inserted into said support surface and to cooperatively engage said first end of said vertical support member to support said vertical support member in a generally vertical position above said support surface, said first end of said vertical support member configured to be slid over, placed into or attached to said ground support member;
an insect attracting light mounted substantially adjacent to said vertical support member, said insect attracting light having at least one source of light;
an insect immobilizing element mounted on said vertical support member in a generally vertical upright position substantially adjacent to said insect attracting light and/or said vertical support member, said insect immobilizing element having a mesh screen with a plurality of openings therein, said openings sized and configured to substantially allow small flying insects to pass therethrough without contact with said one or more adhesive surfaces, said insect immobilizing element is configured to allow light from said insect attracting light to pass therethrough, said mesh screen having one or more adhesive surfaces thereon;
a battery electrically connected to said insect attracting light; and
means for recharging said battery electrically connected to said battery.
